(19) United States
(12) Patent Application Publication
(10) Pub. No.: US 2024/0096509 A1
(43) Pub. Date: Mar. 21, 2024

(54) ELECTROMAGNETIC CONFINEMENT OF PLASMA IN A CONTROLLED FUSION REACTOR

(71) Applicants: Ramesh Chandra, Fremont, CA (US); Monica Chandra, Fremont, CA (US)

(72) Inventors: Ramesh Chandra, Fremont, CA (US); Monica Chandra, Fremont, CA (US)

(21) Appl. No.: 18/093,517

(22) Filed: Jan. 5, 2023

Related U.S. Application Data
(60) Provisional application No. 63/298,787, filed on Jan. 12, 2022.

(51) Int. Cl. G21B 1/05

(52) U.S. Cl. CPC G21B 1/057

(57) ABSTRACT

We describe, herein, a new class of controlled fusion machines that are expected to successfully implement confinement of the hot plasma using a set of electric and magnetic fields. It includes usage of electrostatic charges along with a large ratio of the concentration of positively charged nuclei to the concentration of negatively charged electrons. It would lead to a stable steady state with a very high Q value that is expected to be orders of magnitude higher than achieved so far by any of the controlled fusion machines. Even though usage of superconductors or near superconductors is not necessary to achieve this performance, it is desirable to use superconductors for optimal performance. So, in some of the preferred embodiments of the invention, superconductor or near superconductor structures are built into the design of the machine itself, even though, it is possible to just use superconductors or near superconductors as stand-alone components in the machine.

The present invention allows us to confine plasma in a fusion reactor using very strong electromagnetic fields. Strong electric and magnetic fields are optionally produced through usage of new type of conductors including superconductors invented by us that are functional at almost any temperature. However, it should be noted here that usage of these new type of conductors/superconductors is not a prerequisite for its proper operation. These strong fields also serve to heat up the plasma which would aid in the fusion reactions. The invention described herein also makes use of the electric fields produced by electrostatic charges.

### BACKGROUND

Fusion reactions take place at extremely high temperatures of around 100 million degrees. Therefore, it is not possible to contain such a hot plasma in a physical container. Therefore, attempts have been made to confine the plasma using very strong magnetic fields which would cause the charged particles to circle around the magnetic field lines. Such attempts have not been very successful in producing fusion power in a sustained manner.

One such attempt was to bend a solenoid into a torus. When a current is passed through the coil of the torus, magnetic field lines would be circles along the torus. It was expected that the charged particles would be trapped circling around these field lines. However, it was observed that the electrons drifted away from the nuclei leading to large voltages. It was observed that the plasma ring would expand and hit the walls of the reactor.

Attempts were made to develop a system known as z-pinch to contain the hot plasma. Due to Lorentz force, parallel currents in the plasma cause the plasma to stay together thereby eliminating the need to use external magnets for the plasma confinement. Various teams in the UK built experimental devices to study the feasibility in late 1940s. However, they were unsuccessful in their attempts.

Former German scientist Ronald Richter living in Argentina, completed the Huemul Project in 1951 using electrical arcs and mechanical compression (sound waves) for heating and confinement but without success.

Project Matterhorn led by Spitzer in 1951 tried to correct the problem of outward drift toward the reactor walls by twisting one end of the torus compared to the other forming a figure resembling 8. This way magnetic lines were no longer circular but rather travelled closer and farther from the torus center. So, now a charged particle would travel in and out across the minor axis of the torus. Various layouts of the coil magnets were tried but failed to achieve the desired outcome. To heat the plasma to high temperatures, Spitzer used magnetic pumping which consisted of usage of a radio frequency source. He chose frequency of the source to be the same as the cyclotron frequency. This would cause charged particles to gain energy and try to move in wider radius resulting in collisions with other particles raising temperature of the plasma. However, all these efforts still did not yield the desired results.

By mid-1960s the tokamak designs by Russian scientists began to show greatly improved performance. Even though it was met with great skepticism initially, by 1969 it generated a mad rush for building tokamak type of fusion reactors all over the scientific world. Unlike the stellarator, a large circular current is made to pass through the plasma contained in the torus by the circular magnetic lines produced by the coil of the torus. This current is generated by a transformer type of action using the inner poloidal field coils acting as the primary of the transformer. This current serves a dual purpose of aiding in the confinement as well as ohmic heating of the plasma. Outer poloidal field coils are used for positioning as well as shaping of the plasma. The result is that helical magnetic field lines are generated which tend to confine the plasma. Even though it seems to improve the performance of the fusion reactor, it still does not lead to a stable steady state needed for a practical power generation.

Tokamak fusion reactors have not yet reached the breakeven point characterized by Q=1. The European tokamak (JET) holds the current record which succeeded in generating Q=0.67. In 2006, ITER (International Thermonuclear Experimental Reactor) was organized with seven international partners. Their aim is to achieve Q≥10. For this they intend to use a confining magnetic field of 5.3 Tesla and pass a current of about 15 mega amperes through the plasma. An input thermal power of 50 megawatts is needed to raise temperature of the plasma to about 150 million degrees Celsius. It is expected that it would generate at least 500 megawatts of thermal power. This would generate a “burning” plasma with helium nuclei (alpha particles) carrying about 20% of the energy and the rest 80% is carried by the generated neutrons. Neutrons not being charged would freely hit the walls and the resulting heat would then be utilized for generation of pressurized hot steam that can drive a turbine for generation of electricity. Three heating systems will be utilized: electron cyclotron resonance heating (ECRH), capable of injecting up to 20 megawatts of thermal energy; ion cyclotron radio frequency heating (ICRF), with a similar 20 megawatts maximum heating capability; and the neutral beam (NB) heating system, capable of injecting a maximum of 33 megawatts into the plasma. Thus, 73 megawatts of plasma heating will be available for ITER operation, well above the 50 megawatts required. It will be using 400 second pulses. They expect to test ITER operation by 2035.

### BRIEF SUMMARY OF THE INVENTION

Here we describe procedures and mechanisms to produce an entirely new class of machines to harness the fusion power by a novel scheme for the plasma confinement and heat generation. This machine would allow for a far superior confinement of the hot plasma. It also provides for relatively easy control of both confinement as well as heating. One of the mechanisms to achieve this is to independently control the population densities of the positively charged nuclei as well as the electrons. In addition, it requires far smaller energy input to achieve the desired results than any of the current or planned fusion machines resulting in far greater value for Q than any of the existing or planned fusion machines. This machine is expected to work in a steady state mode.

### BRIEF DESCRIPTION OF THE DRAWINGS

Some embodiments of the present invention are illustrated as an example and are not limited by the figures of the accompanying drawings, in which like references may indicate similar elements and in which a reference to a figure refers to all its parts. In general, part B of a figure, herein, reveals the internal details of the system or component through a vertical cut up or cross section of the system or component. Sometimes, the internal details may be revealed by simply lifting the lid. Explicit electrical connections are not part of the drawings herein. A brief description of the drawings is as follows:

FIG. 1 depicts one example of a configuration of magnetic and electrical fields needed to achieve the desired confinement of the hot plasma for sustained fusion reactions. The electric and magnetic fields employed here are a mix of static and time-varying fields.

FIG. 2A, along with FIG. 2B, depicts one example of a configuration of a fusion machine to achieve electric and magnetic fields illustrated in FIG. 1. It shows independent feeding of the positively charged nuclei as well as negatively charged electrons into the container where fusion reactions would take place. It also shows input for the neutral beams which may aid heating of the plasma.

FIG. 3A, along with FIG. 3B, illustrates the solenoid and conductor assembly placed in the central part of the reaction chamber that is employed to produce auxiliary electric and magnetic fields.

### DETAILED DESCRIPTION OF THE INVENTION

The terminology used herein is only to describe particular embodiments of our invention and should not be regarded as limiting of the invention. Herein, the term “and/or” would include any and all combinations of one or more associated items. Singular words such as “a”, “an,” and “the” are used herein to include both the singular as well as plural meanings, unless the context clearly indicates otherwise. In addition, usage of the terms “comprises” and/or “comprising” are intended to mean not only the stated elements, components, features, steps, and operations, but may also mean presence or addition of other elements, components, features, steps, and operations, or a combinations thereof.

Unless otherwise stated, all terms, including scientific/technical terms used herein, would have the same meaning as commonly used by a person having ordinary skills in the art related to the invention described herein. It should be understood that the terms used herein, should not necessarily be used in the formal or idealized sense, as defined by commonly used dictionaries, but rather their meaning must be understood in the context of the relevant art and the current disclosure.

In disclosing the invention, a number of steps and techniques are described herein. Each one of these has its own particular benefit. However, each one of these can be used in a partial or full combination of all of them. All of these combinations will not be described here because that is not necessary to describe the invention. However, all of these combinations are within the scope of the invention, including the specification and claims, disclosed herein.

Controlled fusion power machine, apparatuses, concepts, and methods for producing various components, and features are discussed herein. In the disclosure herein, many of the specific details are meant to help one understand the invention. However, it should be clear to anyone with ordinary skills in the relevant art that the invention would work just fine even without these specific details.

The disclosure of the invention herein should be considered only as an example of the invention and must not be considered as limited to specific embodiments of the invention as illustrated by drawings/figures or description herein.

The present invention will now be described by referencing the appended figures illustrating a number of preferred embodiments. Here, we describe an entirely new class of controlled fusion power machine. Methods or procedures for producing a plasma wherein concentration of positively charged nuclei and negatively charged electrons can be independently controlled, are described herein. This would allow us to produce extremely large currents in the plasma without causing instabilities. In fact, a large current would tend to help confine the plasma due to the “pinching” effect. A combination of very strong magnetic, electric, and electrostatic fields is used to contain the plasma. Various means of heating the plasma are described herein. Presence of extremely large plasma currents, independent control of the concentrations of positively charged nuclei and negatively charged electrons, and effective control of various fields contribute significantly to the goal of heating the plasma without causing instabilities. Even though it is not mandatory, extensive use of a new class of superconductors at room temperatures may be made to produce very strong magnetic fields for effective containment of the plasma. However, it is expected that the controlled fusion power machine described herein may not require as strong magnetic fields as the ITER machine being pursued currently. In addition, production of these very strong magnetic fields would require only a very small fraction of the energy input needed for production of the same in the ITER machine. This would lead to a Q value that would be orders of magnitude higher than the one expected for the ITER machine. Our controlled fusion power machine would operate in a steady state mode. Preferred embodiments of the mechanism to achieve this is described next:

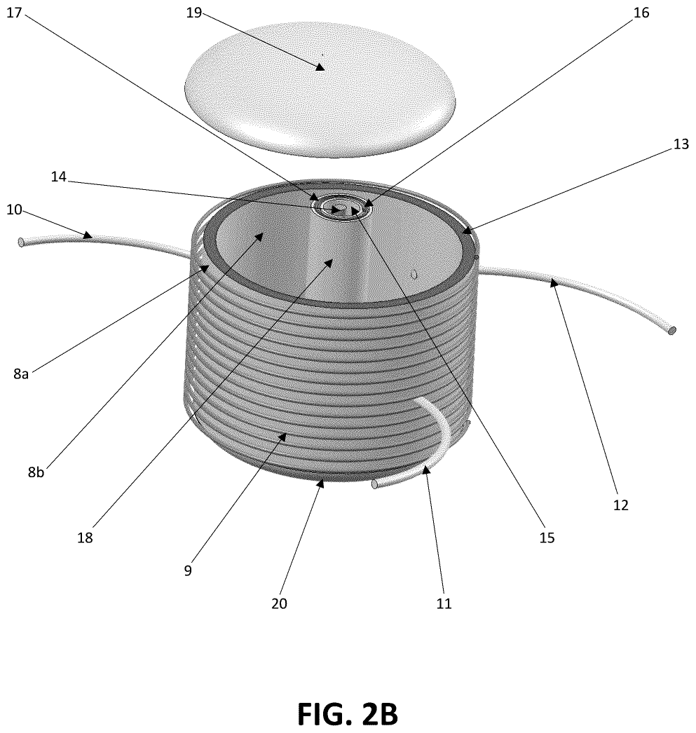

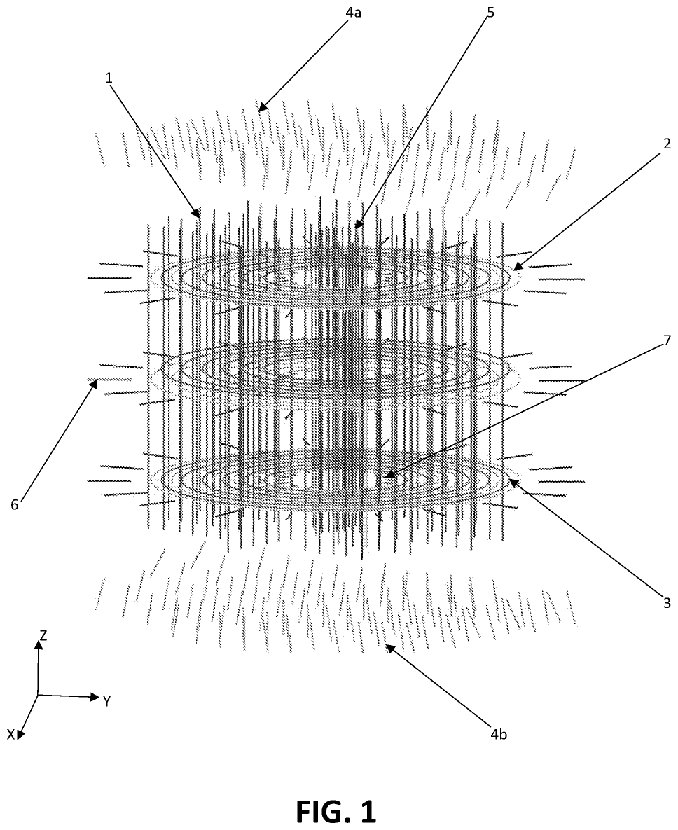

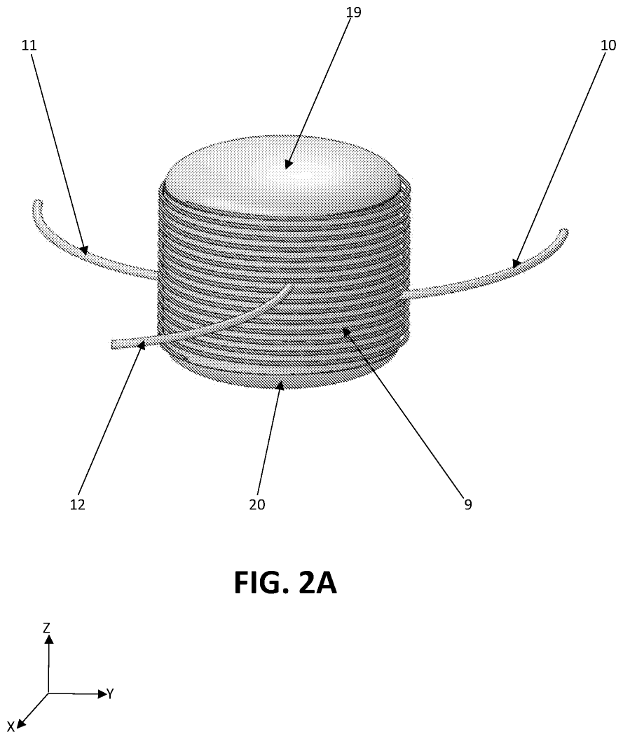

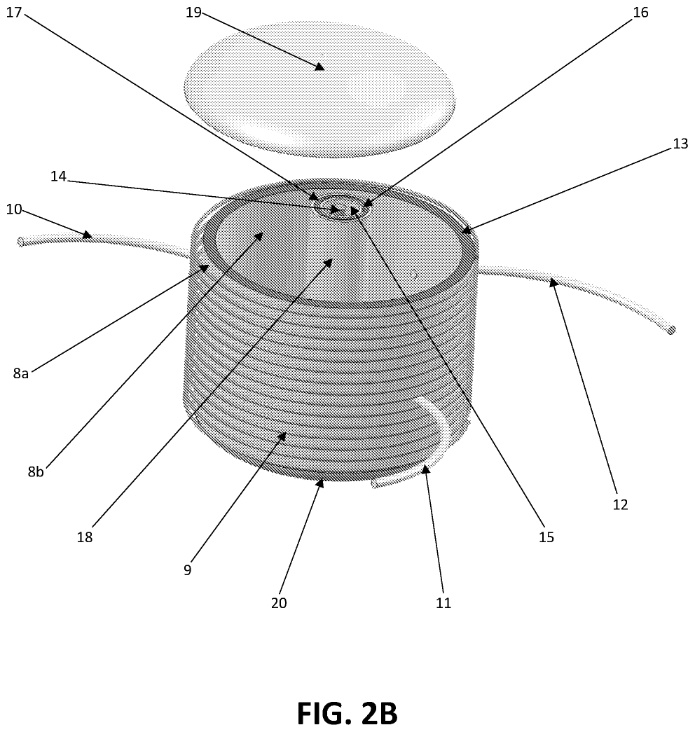

FIG. 1 represents an example of one preferred embodiment or configuration of the various fields used for the effective containment of the hot plasma. Strong magnetic field lines 1 are produced parallel to the z-axis that would tend to trap charged particles to circling in planes that are perpendicular to the z-axis. An auxiliary magnetic field depicted by circular field lines 2 in the planes that are perpendicular to the z-axis aid in arresting a possible drift or migration of the charged particles in a direction parallel to the z-axis. Circular electric field lines 3 in planes perpendicular to the z-axis are induced by superimposing a time varying magnetic field parallel to the z-axis. A positively charged container gives rise to the electrostatic field lines 4a, 4b, and 6 that are used to repel the dominant positively charged particles away from the walls of the container, such as the one shown in FIG. 2A. Another set of auxiliary magnetic field lines 5 are produced by passing a current through a solenoid that may be centered along the z-axis. By passing a time-varying current through the solenoid windings, we would generate an auxiliary set of electric field lines 3 circling in planes perpendicular to the z-axis. This would provide an additional control over confinement of the plasma as well as heating. It is desirable to house this solenoid inside a positively charged cylinder so as to repel the dominant positively charged particles away from the solenoid. Field lines 7 in FIG. 1 represent the electrostatic field generated by the positively charged cylindrical housing for the solenoid as described later.

FIG. 2A, along with FIG. 2B, illustrates one of the preferred embodiments of the overall controlled fusion power machine. Fusion reactions take place inside the charged double-walled container 8 with the outer and inner walls labelled as 8a and 8b respectively. This cylindrical container has a double walled lid 19 on top. Similarly, it has a double walled bottom 20. The walls 8a and 8b of the container can be used to positively charge the inner wall 8b through a capacitive action by applying a voltage between the walls 8a and 8b. Similarly, the inner walls of the lid 19 and the bottom 20 can be made to acquire positive charge through the same type of capacitive action between the two walls of the double walled lid 19 and, also the double walled bottom 20. So, by maintaining positive charge on all the inner walls of the container, the dominant positively charged particles can be repelled away from all these walls. It is desirable to have a dielectric material in between the inner and outer walls of the container including those of the lid and the bottom of the container. Presence of a dielectric material would increase the capacitance between the inner and outer walls. The dielectric material is explicitly shown in FIG. 2A and FIG. 2B between the two walls 8a and 8b of the cylinder and is labeled as 13.

Magnetic field represented by the field lines 1 (depicted in FIG. 1) are generated by passing a current through the coil 9 wrapped around the outer wall 8a of the cylindrical double walled container. The coil is insulated and does not make electrical contact with the walls. By superimposing a time-varying component of current through coil 9, we can also generate circular electric fields in the planes perpendicular to the z-axis that can aid the electric field lines 3 that are generated by the time varying component of current through the solenoid as described above and illustrated in FIG. 1. It should be noted here that the capacitive action through application of a voltage between walls 8a and 8b causes the inner wall 8b to acquire a positive charge as described above. At the same time, the outer wall 8a would, therefore, acquire a negative charge. A large negative charge on outer wall 8a would tend to lower the resistivity of coil 9. This is the subject of a separate patent application by us. Lowering of resistivity would, in turn, reduce the resistive losses, a rather desirable outcome but not necessarily a required outcome for normal operation of the said controlled fusion machine.

Positively charged nuclei enter the reaction chamber or container 8 through the tube 10 in FIG. 2A and FIG. 2B. Similarly, electrons are injected into the reaction chamber 8 through another tube 11. Initially, both the charged particles are expected to traverse in circles on the planes perpendicular to the z-axis. However, the nuclei and electrons having opposite charges, are expected to circulate in opposite directions. Trajectory of these charged particles can be controlled by controlling the speed and angle at which they enter the reaction chamber 8. Trajectory of these charged particles through tubes 10 and 11 can be facilitated by imposing external magnetic fields parallel to the z-axis surrounding these tubes outside the reaction chamber 8. The apparatus for this has not been explicitly shown herein. Similarly, the apparatus for production of the charged nuclei and electrons is also not explicitly shown herein.

Neutral beam injection into reaction chamber 8 is carried out through tube 12. Neutral beam is used for heating of plasma through collisions with various constituent particles in reaction chamber 8.

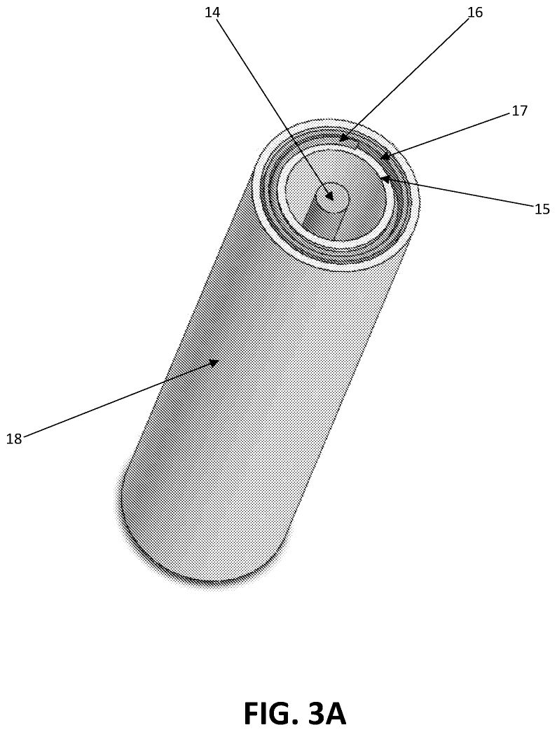

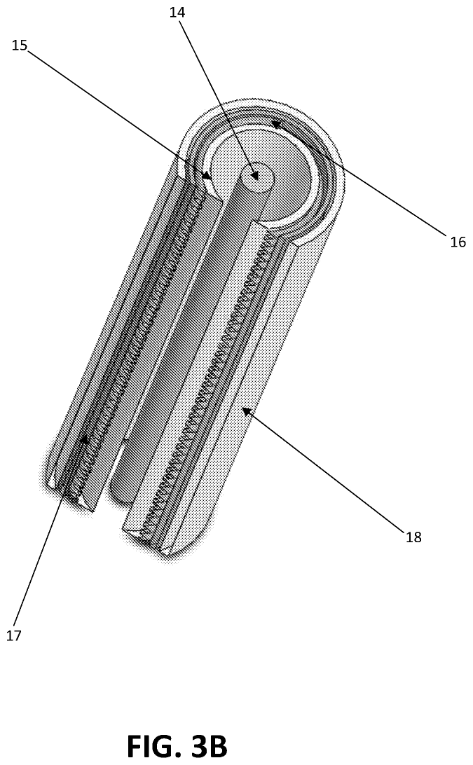

An auxiliary magnetic field 5 (FIG. 1) parallel to the z-axis is generated by passing a current through the solenoid coil 16, as illustrated in FIGS. 2A and 3A. FIG. 3A, along with FIG. 3B, shows only the coil assembly and conductor 14 located at the central part of the reaction chamber in FIG. 2A and FIG. 2B. By passing a time-varying component of current through coil 16, an electric field illustrated by the circular field lines 3 (FIG. 1) is generated. This auxiliary electric field is superimposed on the already existing electric field generated by passing a time-varying component of the current through the solenoid coil 9. By appropriately synchronizing the currents through coil 9 and coil 16, the two circular electric fields can be made to reinforce each other. A current through solenoid 16 would, without shielding at its endings, tend to generate magnetic fields in the region outside the solenoid and tend to contribute little to the already existing magnetic field 1. Similarly, a time-varying component of current through solenoid 16, would also generate electric fields in planes perpendicular to the z-axis which would help heat up the plasma. In FIG. 3A, along with FIG. 3B, the cylindrical walls 15 and 18 are made to acquire negative and positive charge respectively. This is accomplished through the capacitive action by applying a suitable voltage between the two cylindrical walls 15 and 18. A dielectric material labeled as 17 between these two walls may be utilized to increase this capacitance. Positively charged outer wall 18 would tend to repel away the dominant positively charged particles away from the solenoid assembly. At the same time, a large negative charge on the inner cylindrical wall 15 would tend to lower resistivity of the coil 16, thereby allowing a large current to flow through this coil with minimal resistive losses. This is a helpful outcome but not a required or mandatory outcome.

Conductor 14, as illustrated in FIGS. 2A and 3A, is situated along the z-axis. A current through conductor 14 would generate magnetic field illustrated in FIG. 1 as concentric field lines 2 in planes perpendicular to the z-axis.

Now, operation of the controlled fusion power machine, described above, would be detailed herein. After the positively charged nuclei and negatively charged electrons are injected in the opposite directions into the reaction chamber 8, they would tend to circle around the z-axis in the opposite directions on planes perpendicular to the z-axis due to the presence of the magnetic field 1, as depicted in FIG. 1, which is parallel to the z-axis. Presence of the circular auxiliary magnetic field 2 would tend to arrest a drift of the particles along the z-axis. It is important to use an optimum ratio of the concentration of positively charged nuclei to that of the negatively charged electrons. Let us call this ratio as “Particle Concentration Ratio” with an acronym PCR for it. Presence of electrons would help in heating of plasma at the expense of the stability. So, it is desirable to keep electron density significantly lower than that of the nuclei, i.e., we would use a large value for PCR. Infinite value for PCR would lead to a superconducting fluid or plasma with negligible ohmic heating at ordinary temperatures. With a large value for PCR, electrons would remain confined within the space dominated by the positively charged nuclei which, in turn, remain pushed away from the positively charged container walls and the outer positively charged walls of the housing for solenoid 16. A very hot plasma remains ionized and the dominant population of positively charged nuclei makes it much easier for them to collide and fuse together releasing vast amount of energy in the process. The charged particles, especially the dominant positively charged nuclei, would remain confined away from the walls due to the presence of strong magnetic fields 1 and 2 along with the electrostatic fields 4(4a and 4b), 6 and 7 as shown in FIG. 1. It may be noted here that it may be desirable to cover the top and bottom of the housing 18 with double-walled “lids” so as to make the outer walls of these “lids” acquire positive charges through a capacitive action, as described above. This would help repel the dominant positively charged nuclei away from the solenoid assembly.

By superimposing a time-varying component of electric current through coil 9, we would also generate the circular electric field 3. The induced electric field strength would increase with distance from the z-axis. An auxiliary electric field can also be generated by passing a time-varying current through coil 16. The associated electric field lines would also form along the concentric circles as illustrated by 3. However, strength of this induced electric field would decrease with distance from the z-axis. Therefore, it would tend to even out the electric field strength throughout the plasma. We would need to synchronize the time varying components of the currents through the two coils (9 and 16). The combined electric field would tend to accelerate the charged particles resulting in larger currents thereby causing larger ohmic heating of the plasma. The plasma would tend to remain confined away from the walls of the reaction chamber due to the presence of strong static component of magnetic fields 1 and 2 along with the electrostatic fields 4(4a and 4b), 6 and 7 as illustrated in FIG. 1. The time-varying components of the currents through coils 9 and 16 may be in the form of long pulses or sinusoidal and they should be synchronized for effective ohmic heating of the plasma. If we superimpose a time-varying current component on the existing constant current flowing through conductor 14, it would aid in thermalization and therefore heating of the plasma by inducing additional electric fields in planes perpendicular to the magnetic field 2. This thermalization can be further improved by introducing neutral impurities in the reaction chamber. Other heating mechanisms such as neutral beam (NB), ion cyclotron radio frequency heating (ICRF), and electron cyclotron resonance heating (ECRH) may also be employed to achieve the desired result.

It may be noted here that it is not necessary to use all the electric and magnetic fields at the same time to effectively confine the plasma. Different combinations of these fields may be enough for effective confinement of the plasma. As an extreme example, it should be enough to confine the plasma by simply establishing very large positive charge densities on the walls of the reaction chamber and using a very large value for PCR. It would tend to minimize energy input at the cost of having to use much larger size for the reaction chamber. In addition, the reaction chamber itself would need to be enclosed by a larger vacuum chamber to avoid sparking and charge leakage. In the preferred embodiments of the invention, described above, superconductor or near-superconductor structures are built into the design of the machine itself. However, we could have used the superconductors or very low resistivity conductors as stand-alone components in the machine. It may also be noted herein that these type of superconductors or very low resistivity conductors that are functional at almost any temperature are based on another patent filing by us. It is important to note that usage of superconductors or very low resistivity conductors is not necessary for successful operation of the invention described herein. It may be noted that usage of electrostatic fields to increase electrical conductivity of a component also has a bearing on the thermal conductivity of the same.

There is a scope for vastly improving confinement of the hot plasma inside a tokamak by employing some of the mechanisms or procedures described above. So, the following changes to the design of the current tokamaks will vastly improve confinement of the hot plasma inside a tokamak: The particle concentration ratio (PCR) should be made much greater than 1 and equal to an optimum value. Electrons should be injected into the torus in a direction opposite to that of the positively charged nuclei. It is desirable to accelerate both the positively charged nuclei as well as the negatively charged electrons to high speeds before being injected into the torus in presence of the magnetic field produced by the torus coil. The torus wall should be positively charged to repel any dominant positively charged nuclei that may drift toward the wall of the torus. If we add another high current capacity wire cable along the z-axis inside the inner poloidal field coils, it can be made to add to the strong magnetic field produced by the large current through the torus coil. This additional magnetic field can be used to control or modulate the original magnetic field produced by the current in the torus coil. With these changes, we may not need the outer poloidal field coils. With much better confinement of the plasma now, it would be possible to operate in the desirable steady state mode by passing a time varying current through the inner poloidal field coils. In addition, by superimposing a time-varying current on the existing static current through the torus coils, thermalization and hence ohmic heating can be made more effective.

What is claimed is:

1. A controlled fusion machine comprising:
magnetic fields parallel to the z-axis produced by current through the coil wrapped around the container and also by passing an electric current through the solenoid in the central region of the reaction chamber;
circular magnetic fields in planes perpendicular to the z-axis produced by passing current through the conductor along the z-axis;
circular electric fields in planes perpendicular to the z-axis induced by a time-varying component of current passing through said coil wrapped around said reaction chamber, and also by passing a time-varying component of current through said solenoid serving dual purpose of plasma confinement by arresting drifts and also heating of plasma;
induced electric field by passing a time-varying component of electric current through said conductor placed along the z-axis used primarily for heating through thermalization;
electrostatic fields produced through electrostatic charges on the double-walled lids/bottom and double-walled cylindrical walls of said reaction chamber such that the respective inner walls acquire large positive charges thereby repelling the dominant positively charged nuclei away from the walls of said reaction chamber and at the same time the outer wall's large negative charge would tend to lower electrical conductivity of said coil wrapped around said reaction chamber;
positively charged cylindrical housing enclosing said solenoid in the central region of said reaction chamber with optional double walls for making outer surface acquire positive charge through capacitive action as described earlier and at the same time a large negative charge on the inner wall of said housing would tend to lower electrical conductivity of said solenoid;
power source used for charging of said walls of said reaction chamber through capacitive action on said walls through its connection to the sets of said parallel walls of said reaction chamber, and said set of parallel walls may have dielectric material separating them;
negatively charged electrons and positively charged nuclei for fusion reaction are introduced into said reaction chamber in opposite directions so as to circulate in opposite directions in circles in planes perpendicular to z-axis with an optimum Particle Concentration Ratio (PCR);
neutral beam for heating purpose is introduced into said reaction chamber through a separate tube into said reaction chamber.

2. Improved tokamak controlled fusion machine utilizing some of the concepts detailed above comprising:
a large value, much greater than one, for PCR and injecting externally accelerated electrons and positively charged nuclei into reaction chamber in opposite directions;
positively charged walls of said reaction chamber to help repel the dominant positively charged nuclei;
a high current-carrying conductor along z-axis to produce additional circular magnetic field that can be used to control or modulate the original magnetic field produced by the current through the torus coil which may eliminate the need for the outer poloidal field coils;
time-varying component of currents through said conductor along z-axis and said torus coil to aid ohmic heating.
